(19) United States
(12) Patent Application Publication
(10) Pub. No.: US 2026/0172451 A1
(43) Pub. Date: Jun. 18, 2026

(54) Cybersecurity Reinforcement Learning Agent

(71) Applicant: CrowdStrike, Inc., Sunnyvale, CA (US)

(72) Inventors: Arnd Korn, Berlin (DE); Ian Torres, Spring Branch, TX (US)

(73) Assignee: CrowdStrike, Inc., Sunnyvale, CA (US)

(21) Appl. No.: 18/982,060

(22) Filed: Dec. 16, 2024

(51) Int. Cl. H04L 9/40; G06F 21/53; H04L 41/16

(52) U.S. Cl. CPC H04L 63/20; G06F 21/53; H04L 41/16; H04L 63/101; H04L 63/1425

(57) ABSTRACT

An endpoint cybersecurity reinforcement learning agent uses reinforcement learning to implement cybersecurity actions. The endpoint cybersecurity RL agent interfaces with a host operating system as an antimalware driver. The endpoint cybersecurity RL agent receives an event notification generated by the OS and determines a responsive cybersecurity action using the reinforcement learning. The endpoint cybersecurity RL agent implements the cybersecurity action via the OS. The endpoint cybersecurity RL agent thus greatly improves computer functioning by quickly learning to identify new/novel suspicious events and operations.

### BACKGROUND

The subject matter described herein generally relates to computers and, more particularly, the subject matter relates to network/computer security monitoring and to reinforcement machine learning.

Cybersecurity attacks are increasing. Nearly every day we read of another virus, intrusion, data breach, or malware. Prudent computer users thus rely on cybersecurity services to thwart cybersecurity attacks. Conventional cybersecurity services, though, often prove ineffective in catching novel cybersecurity threats. Conventional cybersecurity services, for example, may employ rule-based and signature-based schemes to detect cybersecurity threats. Rules and signatures, though, often fail to detect new or unknown threats. More advanced cybersecurity services employ machine learning techniques. Machine learning, though, often requires large training datasets that have been pre-classified as safe/benign/malicious/harmful. Again, though, pre-classified data often fails to detect new or unknown threats. Moreover, the pre-classified data requires much time and cost to create.

### SUMMARY

An elegant reinforcement learning scheme greatly improves computer functioning. An endpoint cybersecurity reinforcement learning (or RL) agent uses reinforcement learning to implement cybersecurity actions. The endpoint cybersecurity RL agent interfaces with a host operating system as an antimalware driver. The endpoint cybersecurity RL agent registers for event notifications from the operating system. When the endpoint cybersecurity RL agent receives an event notification, the endpoint cybersecurity RL agent uses the reinforcement learning to determine a responsive cybersecurity action. The endpoint cybersecurity RL agent then implements the cybersecurity action by interfacing with the operating system as the antimalware driver. As an example, before a kernel of the operating system executes any file system operation (such as opening, closing, or downloading a computer file), the kernel notifies the endpoint cybersecurity RL agent and awaits instructions. The endpoint cybersecurity RL agent uses reinforcement learning to determine whether the computer file is safe or unsafe. The endpoint cybersecurity RL agent then instructs the kernel to implement the responsive cybersecurity action (e.g., block or allow the file system operation). The endpoint cybersecurity RL agent greatly improves computer functioning by quickly learning safe/suspicious operations using reinforcement rewards and penalties.

### BRIEF DESCRIPTION OF THE SEVERAL VIEWS OF THE DRAWINGS

The features, aspects, and advantages of a cybersecurity reinforcement learning agent are understood when the following Detailed Description is read with reference to the accompanying drawings, wherein:

FIG. 1 illustrates some examples of a cybersecurity reinforcement learning agent;

FIG. 2 illustrates some examples of host monitoring;

FIG. 3 illustrates examples of a cloud-based cybersecurity intrusion detection service;

FIGS. 4-5 illustrate architectural examples of a reinforcement learning feedback loop;

FIGS. 6-7 illustrate examples of an entitative replay buffer;

FIG. 8 illustrates examples of triggering agent experiences;

FIGS. 9-11 illustrate examples of methods or operations that implement cybersecurity actions using reinforcement learning; and

FIG. 12 illustrates a more detailed example of an operating environment.

### DETAILED DESCRIPTION

Some examples relate to detection of suspicious computer operations. Nearly every day we read of yet another intrusion into a computer system. Malware users can steal passwords, social security numbers, photos, and other personal information. Malware users can even steal money from our bank accounts. These persons or groups (also referred to herein as “adversaries”) usually trick an innocent user into clicking some nefarious link that downloads malicious software. The malicious software then opens, copies, or transfers computer files that contain personal/private information. Malicious insiders may also load or execute malicious software. This disclosure describes a cybersecurity reinforcement learning agent that catches and stops threats before information is stolen. The cybersecurity reinforcement learning agent intercepts computer operations before execution. That is, before a computer opens a file, downloads data, or takes other actions, the cybersecurity reinforcement learning agent first analyzes the computer operations and determines whether the computer operations are safe or suspicious. If, for example, the computer operations are good/safe, then the cybersecurity reinforcement learning agent may allow an operating system to perform the computer operations (e.g., open a file or download an email attachment). If, however, the computer operations are unknown, suspicious, or even a known cybersecurity attack, then the cybersecurity reinforcement learning agent may instruct the operating system to block the computer operations. The cybersecurity reinforcement learning agent thus stops adversaries from gaining access to computers.

The cybersecurity reinforcement learning agent is an elegant cybersecurity solution. The cybersecurity reinforcement learning agent uses sophisticated techniques to learn which computer operations should be allowed and which computer operations should be blocked. The cybersecurity reinforcement learning agent, as an example, monitors the computer operations requested by its host operating system. The cybersecurity reinforcement learning agent uses a branch of machine learning (called reinforcement learning) to determine an action to take, in response to the computer operations requested by its host operating system. The cybersecurity reinforcement learning agent, for example, may block or allow the computer operations, depending on a good/bad/safe/malicious determination. Whatever action the cybersecurity reinforcement learning agent takes, the cybersecurity reinforcement learning agent informs its supervisor (such as a cloud service) of the block/allow action. The supervisor then provides feedback in the form of a reward or a penalty. The cybersecurity reinforcement learning agent then uses the feedback as a learning mechanism. In simple words, the cybersecurity reinforcement learning agent learns whether the action, taken in response to the computer operations, was right/wrong/good/bad based on the reward or the penalty.

The cybersecurity reinforcement learning agent greatly improves computer functioning. The cybersecurity reinforcement learning agent protects its host computer from cybersecurity threats. The cybersecurity reinforcement learning agent, in particular, adapts to novel cybersecurity threats. Adversaries are always changing their schemes to avoid detection. Conventional cybersecurity schemes simply do not detect new or unknown threats until after much effort, analysis, and time. The cybersecurity reinforcement learning agent, however, quickly adjusts its behavior based on the reward or the penalty. The reward and/or the penalty cause the cybersecurity reinforcement learning agent to learn from its successes and mistakes. The cybersecurity reinforcement learning agent thus quickly adapts and provides a much faster response to novel cybersecurity threats. The cybersecurity reinforcement learning agent constantly learns, in near real time through trial and error, to provide the best threat detection and mitigation.

The cybersecurity reinforcement learning agent will now be described more fully hereinafter with reference to the accompanying drawings. The cybersecurity reinforcement learning agent, however, may be embodied and implemented in many different forms and should not be construed as limited to the examples set forth herein. These examples are provided so that this disclosure will be thorough and complete and fully convey the cybersecurity reinforcement learning agent to those of ordinary skill in the art. Moreover, all the examples of the cybersecurity reinforcement learning agent are intended to encompass both structural and functional equivalents thereof. Additionally, it is intended that such equivalents include both currently known equivalents as well as equivalents developed in the future (i.e., any elements developed that perform the same function, regardless of structure).

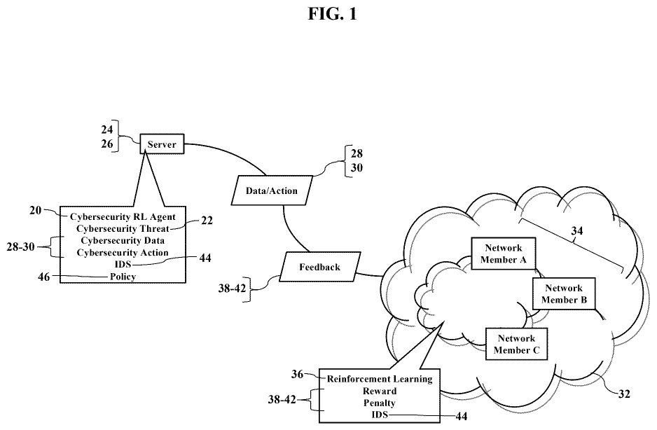

FIG. 1 illustrates some examples of a cybersecurity reinforcement learning agent 20. The cybersecurity reinforcement learning (or RL) agent 20 detects cybersecurity threats 22 that attack its endpoint host computer system 24. FIG. 1 illustrates the host computer system 24 as a server 26, but the host computer system 24 may be any processor-controlled device (as later paragraphs will explain). The host computer system 24 stores and executes the cybersecurity RL agent 20 as protection against the cybersecurity threats 22. That is, the cybersecurity RL agent 20 monitors its host computer system 24 for cybersecurity data 28 (as later paragraphs will explain). When the cybersecurity RL agent 20 detects the cybersecurity data 28, the cybersecurity RL agent 20 decides on a responsive cybersecurity action 30 to take. The cybersecurity RL agent 20 instructs its host computer system 24 to implement the cybersecurity action 30. The cybersecurity RL agent 20, however, may also instruct its host computer system 24 to send or upload the cybersecurity action 30 and/or the cybersecurity data 28 (via a communications network, not shown for simplicity) to a supervisory cloud computing environment 32. The cloud computing environment 32 (e.g., public Internet, private network, and/or hybrid network) has many servers, devices, computers, or other networked members 34 that analyze the cybersecurity data/action 28/30 using reinforcement learning (or RL) 36 or other methods. The cloud computing environment 32 then provides feedback 38 in the form of a reward 40 or a penalty 42. The cloud computing environment 32 sends the feedback 38 back to the cybersecurity RL agent 20. The cybersecurity RL agent 20 then uses the feedback 38 as a learning mechanism. In simple words, the cybersecurity RL agent 20 learns whether the cybersecurity action 30, taken in response to the cybersecurity data 28, was right/wrong/good/bad based on the reward 40 or penalty 42.

The cybersecurity reinforcement learning agent 20 greatly improves computer functioning. The cybersecurity reinforcement learning (or RL) agent 20 and the cloud computing environment 32 cooperate to provide an RL-based cybersecurity intrusion detection service (or IDS) 44. Conventional cybersecurity intrusion detection system services, though, are ineffective in detecting novel cybersecurity threats. Conventional cybersecurity schemes simply do not have rules, signatures, and/or pre-classified training data to detect new or unknown threats. The RL-based cybersecurity intrusion detection service 44, however, adapts to novel cybersecurity threats. When the cybersecurity RL agent 20 detects the cybersecurity data 28 and implements the cybersecurity action 30, the cybersecurity RL agent 20 may adjust its behavioral cybersecurity policy 46 based on the reward 40 or the penalty 42. The cybersecurity RL agent 20, for example, refines its cybersecurity performance and capabilities by maximizing the incentives/rewards 40 and/or by minimizing the penalties 42. The reward 40 and/or the penalty 42 thus cause the cybersecurity RL agent 20 to learn from its successes and mistakes. The reward 40 and/or the penalty 42 may have whatever representation, value, or other content is desired to suit an objective. The reward/penalty 40/42, for example, may be positive/negative numerical points and/or values. The reward/penalty 40/42, however, may be additions or subtractions of objects, items, currencies, or other collected/hoarded/accumulated (such as coins, tokens, bits, and other units, pieces, or things). Whatever the reward/penalty 40/42, the cybersecurity RL agent 20 thus quickly adapts to new or unknown cybersecurity threats 22. The RL-based cybersecurity intrusion detection service 44 thus provides a much faster response to novel cybersecurity threats 22. Precious time and resources are not spent writing/testing/deploying new rules and signatures. Time and resources are also not spent laboriously classifying massive amounts of training data required for supervised machine learning approaches.

The cybersecurity reinforcement learning agent 20 further improves computer functioning. Because the cybersecurity RL agent 20 is installed to its endpoint host computer system 24, the cybersecurity RL agent 20 protects its host computer system 24 from the cybersecurity threats 22. The cybersecurity RL agent 20 improves the cybersecurity intrusion detection service 44 by constantly, and in near real time, learning through trial and error. The cybersecurity RL agent 20 adjusts its cybersecurity actions 30 and/or its policy 46 based on the reward 40 or the penalty 42. The cybersecurity RL agent 20 is thus rewarded for detecting cybersecurity threats 22 and punished for missing cybersecurity threats 22. The cybersecurity RL agent continuously adapts its behavioral/cybersecurity policy 46 based on the feedback 38 from the supervisory cloud computing environment 32. The cybersecurity RL agent 20 thus learns which cybersecurity actions 30 and/or policies 46 are rewarded for best threat detection and mitigation.

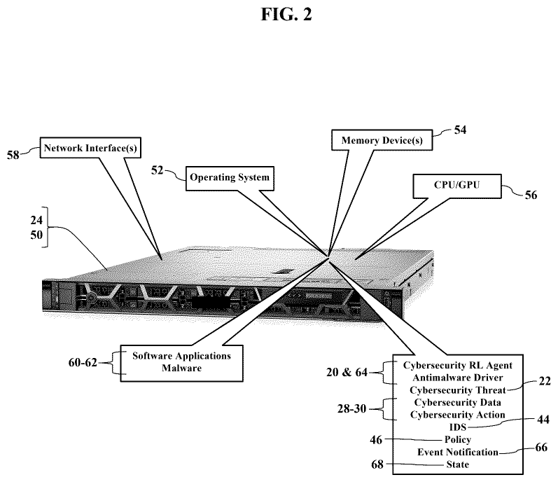

FIG. 2 illustrates some examples of host monitoring. The cybersecurity reinforcement learning (or RL) agent 20 monitors its host computer system 24 for the cybersecurity data 28 that may indicate cybersecurity threats 22. FIG. 2 illustrates the host computer system 24 as a rack server 50, which is commonly installed in server rooms and in server farms. The rack server 50 is programmed to detect the cybersecurity threats 22. The rack server 50 stores and executes an operating system 52 in a memory device 54. The rack server 50 also stores the cybersecurity RL agent 20 in the memory device 54. The rack server 50 has a hardware processor with cores 56 (illustrated as “CPU/GPU”) that reads and executes the operating system 52 and the cybersecurity RL agent 20. The rack server 50 also has network interfaces 58 to multiple communications networks (such as the cloud computing environment 32 illustrated in FIG. 1), thus allowing bi-directional communications with other networked devices and services. The cybersecurity RL agent 20 has programming code or instructions that cause the rack server 50 to perform operations, such as learning which cybersecurity actions 30 and/or policies 46 are rewarded for best threat detection and mitigation.

The cybersecurity RL agent 20, in particular, may monitor for malware 60. The rack server 50 stores many hundreds or thousands of different software applications 62 in the memory device 54. Some familiar packages of the software applications 62 may include a web browser, email, word processing, games, photos, messages, spreadsheet, slide presentation, and cloud storage. Sadly, though, some of the software applications 62 may be corrupted or even malicious software (or malware) 60. The malware 60 seeks to gain unauthorized access to the rack server 50 and to exploit the cybersecurity threat 22.

The operating system 52, however, may recognize the cybersecurity RL agent 20 as an antimalware driver 64. Many operating systems provide mechanisms for antimalware cybersecurity software. Microsoft's Early Launch AntiMalware (or ELAM), for example, allows cybersecurity service providers to start cybersecurity software (such as the cybersecurity RL agent 20) before other third-party software components are initiated. The cybersecurity RL agent 20, for example, may interface with the operating system 52 and advertise itself as an early-launch (or ELAM) boot-start antimalware driver 64. The operating system 52 thus first initializes the cybersecurity RL agent 20 as the antimalware driver 64, and the operating system 52 allows the cybersecurity RL agent 20 to control initialization of subsequent drivers and other software applications 60. The cybersecurity RL agent 20 may thus use the ELAM mechanism to block initialization of unknown or suspicious software (such as according to the policy 46).

The cybersecurity RL agent 20 may thus have permissions. The cybersecurity RL agent 20 is installed on the host computer system 24 (e.g., the rack server 50), is stored by the memory device 54, and is executed by the hardware processor 56. The cybersecurity RL agent 20, for example, may have kernel-level components having kernel-level permissions to a kernel of the operating system 52. The cybersecurity RL agent 20 may additionally have user-mode components having user-level permissions to a user mode of the operating system 52. The cybersecurity RL agent 20 may include computer program, code, or instructions that register with the operating system 52 as the antimalware driver 64. The cybersecurity RL agent 20 may thus register with, or subscribe to, the operating system 52 for event notifications 66. The cybersecurity RL agent 20, for example, specifies the cybersecurity data 28 of interest. The operating system 52 then notifies the cybersecurity RL agent 20, via the event notification 66, when the operating system 52 detects the cybersecurity data 28 of interest. Moreover, because the cybersecurity RL agent 20 is authorized as the antimalware driver 64, the operating system 52 may await instructions or commands from the cybersecurity RL agent 20. So, when the operating system 52 notifies the cybersecurity RL agent 20 of the cybersecurity data 28 (such as via the event notification 66), the operating system 52 may defer or wait until the cybersecurity RL agent 20 decides which responsive cybersecurity action 30 to take. The cybersecurity RL agent 20 instructs the operating system 52 to implement the cybersecurity action 30. The cybersecurity RL agent 20 may also instruct operating system 52 to report the cybersecurity action 30 to the cloud computing environment 32 (illustrated in FIG. 1) and to the cloud-based cybersecurity intrusion detection service (or IDS) 44.

The cybersecurity RL agent 20 specifies the cybersecurity data 28 of interest. The cybersecurity RL agent 20 may instruct the operating system 52 to notify of operating system events, software events, communications, processes, activities, behaviors, data values, usernames/logins, locations, contexts, and/or patterns that indicate potential evidence of the malware 60, cybersecurity threats 22, or other suspicious/abnormal computer behavior. The cybersecurity data 28 may further represent or include streams of events/activities/processes associated with the operating system 52 and/or with other software applications 62. The cybersecurity RL agent 20 may be notified of kernel-level activity and/or user-mode activity conducted by the operating system 52 and/or by other software applications 62. The cybersecurity RL agent 20 may register for and receive kernel-level notifications, user-level notifications, and call backs from the operating system 52. The cybersecurity RL agent 20 may thus interface with the operating system 52 and/or with other software applications 60 to receive any data (such as runtime values, messages, input/output requests, system calls, reads/writes, launches, files, and memory allocations). Whatever the kernel-level activity and/or user-mode activity, the cybersecurity data 28 may represent a current state 68 associated with the host computer system 24 (e.g., the rack server 50) and/or the cybersecurity RL agent 20. The cybersecurity RL agent 20 cooperates with the operating system 52 to report the data/action/state 28/30/68 to the cloud computing environment 32.

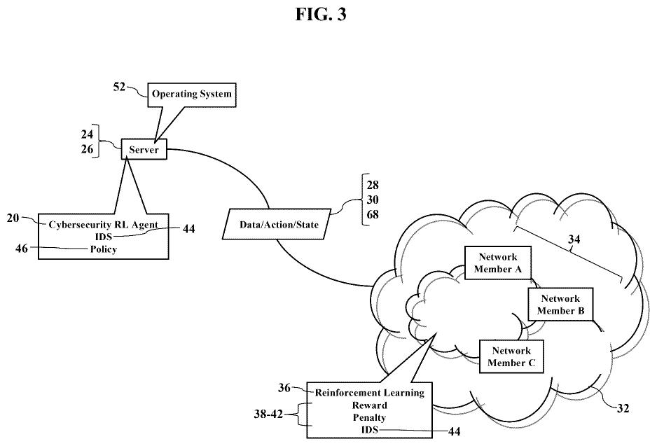

FIG. 3 illustrates more examples of the cloud-based cybersecurity intrusion detection service (or IDS) 44. When the operating system 52 notifies the cybersecurity RL agent 20 of the cybersecurity data 28 and/or the state 68, the cybersecurity RL agent 20 determines the responsive cybersecurity action 30. The cybersecurity RL agent 20 instructs the operating system 52 to implement the cybersecurity action 30 and report the data/action/state 28/30/68 to the cloud-based cybersecurity intrusion detection service 44. The cybersecurity RL agent 20, for example, may cooperate with the operating system 52 to send the data/action/state 28/30/68 to a designated network address associated with the cybersecurity intrusion detection service 44. When the cloud computing environment 32 receives the data/action/state 28/30/68, the cloud computing environment 32 analyzes the data/action/state 28/30/68 and determines the feedback 38.

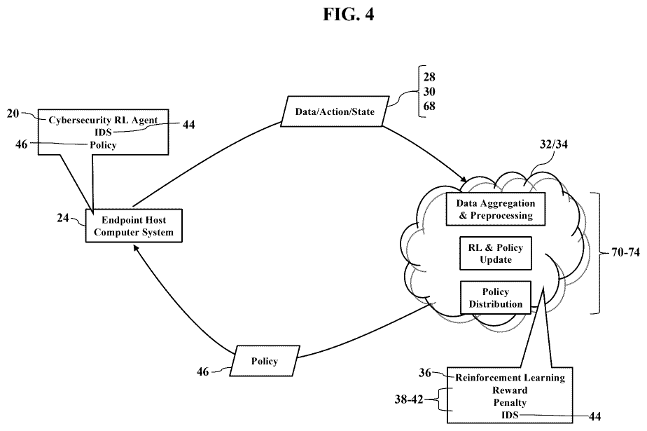

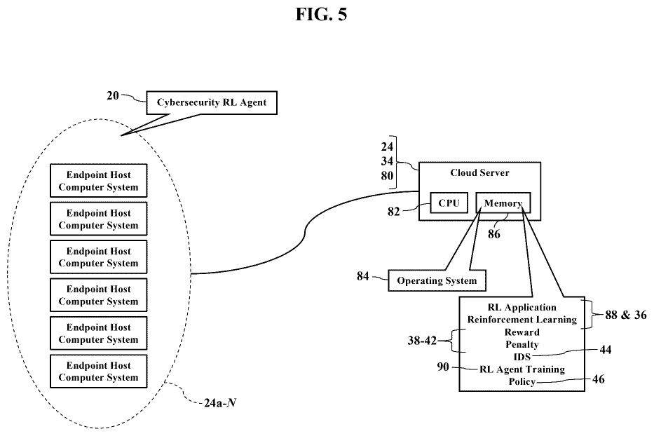

FIGS. 4-5 illustrate architectural examples of the feedback loop. Whatever the data/action/state 28/30/68 generated by the service client (e.g., the host computer system 24 executing the cybersecurity RL agent 20), the cybersecurity RL agent 20 causes the host computer system 24 to upload the data/action/state 28/30/68 to the RL-based cybersecurity intrusion detection service (or IDS) 44. When the cloud computing environment 32 receives the data/action/state 28/30/68, one or more of the networked members 34 (such as a cloud server 80 illustrated in FIG. 5) aggregates and preprocesses the data/action/state 28/30/68 (illustrated as Block 70). The cloud computing environment 32 prepares the data/action/state 28/30/68 into RL agent training data and performs the reinforcement learning 36 (illustrated as Block 72). The cloud computing environment 32 may then distribute the policy 46 to service clients operating in the field (illustrated as Block 74). FIG. 5, in particular, illustrates the cloud server 80 providing at least a portion of the RL-based cybersecurity intrusion detection service (IDS) 44. The cloud server 80 has a hardware processor 82 (illustrated as “CPU”) that executes an operating system 84 stored in a memory device 86. The cloud server 80 also stores and executes a reinforcement learning (or RL) application 88. The RL application 88 cooperates with the cybersecurity RL agent 20, perhaps in a server-client relationship, to provide the RL-based cybersecurity intrusion detection service (or IDS) 44. The RL application 88 instructs the cloud server 80 to execute RL agent training 90 and to generate the agent policy 46. Indeed, if the cybersecurity RL agent 20 was previously trained, then the RL application 88 instructs the cloud server 80 to generate an updated or modified agent policy 46. The RL application 88 may further instruct the cloud server 80 to log the training and policy generation (such as storing the newly generated agent policy 46 or the updated agent policy 46 to the local memory device 86 or to other remote storage location). The RL application 88 instructs the cloud server 80 to send the policy 46 to the service client (e.g., the cybersecurity RL agent 20 installed to the host computer system 24). The RL application 88, however, may further instruct the cloud server 80 to distribute the policy 46 to other cybersecurity RL agents 20 installed to other endpoint host computer systems 24a-N operating in the field. The RL-based cybersecurity intrusion detection service 44, in other words, may deploy and deliver the policy 46 to many other computer systems 22 associated with the same user/customer/corporation/entity.

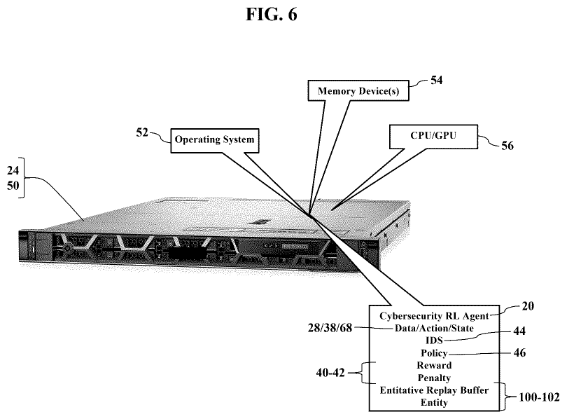

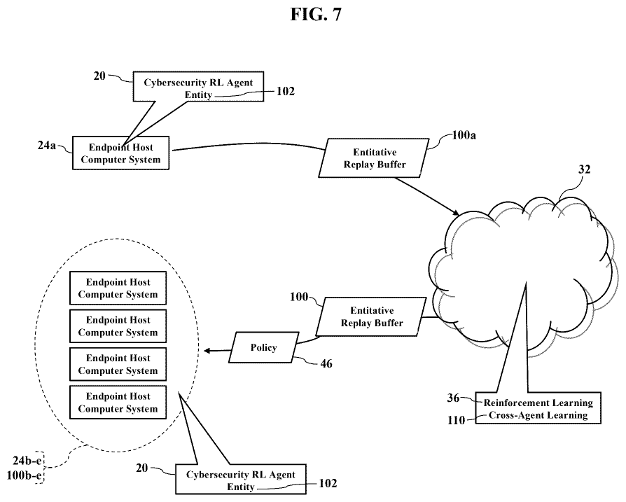

FIGS. 6-7 illustrate examples of an entitative replay buffer 100. The host computer system 24 (again illustrated as the rack server 50) stores the cybersecurity reinforcement learning (or RL) agent 20 to the local memory device 54. As the cybersecurity RL agent 20 operates, the cybersecurity RL agent 20 may log and store its agent experiences (such as the cybersecurity data 28, cybersecurity action 30, and/or state 68). The cybersecurity RL agent 20, for example, may cooperate with the operating system 52 to allocate a byte portion of the memory device 54 to the RL-based cybersecurity intrusion detection service (or IDS) 44. The cybersecurity RL agent 20 may then cooperate with the operating system 52 to write its agent experiences to the entitative replay buffer 100. The entitative replay buffer 100, though, may be associated with a user, group, customer, corporation, or other entity 102. The cybersecurity RL agent 20 may further log the rewards 40 and penalties 42 associated with its agent experiences. The entitative replay buffer 100 may thus be an electronic database that logs each computer experience with a timestamp. Each database entry may thus map, relate, and/or associate the timestamp to the cybersecurity data 28, cybersecurity action 30, state 68, reward 40, penalty 42, and entity 102. Over time, then, the entitative replay buffer 100 stores a rich repository of historical RL agent experiences. The cybersecurity RL agent 20 may thus query the entitative replay buffer 100 and retrieve current/historical agent experiences. The cybersecurity RL agent 20, for example, may compare a current data/action/state 28/30/68 to the historical entries logged to the agent experiences. The entitative replay buffer 100, as examples, may store a probability distribution representing the historical agent experiences. The cybersecurity RL agent 20 may thus compare the current data/state/action/entity 28/30/68/102 to the probability distribution and determine a match or agreement with the historical agent experiences. The cybersecurity RL agent 20 may thus correlate and identify the current data/state/action/entity 28/30/68/102 to historical data/state/action/entity 28/30/68/102 and to its corresponding historical reward 40 or penalty 42. The cybersecurity RL agent 20 may thus select its cybersecurity action 30 based on historical agent experiences most rewarded or penalized.

As FIG. 7 illustrates, the entitative replay buffer 100 may be shared. Because the entitative replay buffer 100 is affiliated with the same user/group/customer/corporation/entity 102, the entitative replay buffer 100 may be deployed to other endpoint host computer systems 24 also affiliated with the same entity 102. The bit/byte contents of the entitative replay buffer 100, for example, may be distributed for faster cross-agent learning 110. In FIG. 7, for example, five (5) host computer systems (illustrated as reference numerals 24a-e) are all commonly associated with group entity 102. Each of the computer systems 24a-e locally stores and executes its corresponding cybersecurity RL agent 20a-e. When one of the cybersecurity RL agents (such as 24a) uploads its agent experiences to the cloud computing environment 32 for analysis, the resulting new/updated agent policy 46 may be sent to the other cybersecurity RL agents 20b-e affiliated with the same entity 102. The bit/byte contents of the entitative replay buffer 100a, in other words, may be shared to fill or populate other entitative replay buffers 100b-e. The cloud computing environment 32, for example, may maintain an entitative distribution list associated with the entity 102. The entitative distribution list contains network/IP addresses assigned to each endpoint host computer system 24 and/or cybersecurity RL agent 20 affiliated with the same entity 102. The same agent experiences may thus be cross-populated across the host computer systems 24 to ensure the cybersecurity RL agents 20 behave according to a unified entity policy 46. The RL-based cybersecurity intrusion detection service 44 may thus cloud aggregate, entitative learning batches for cross-agent learning. Reinforcement learning flows agent experiences via the cloud service 44 to propagate a uniform agent policy 46. The entitative replay buffer 100 may be distributed as a batch for distributed reinforcement learning 36.

The cross-agent learning 110 further improves computer functioning. The cross-agent learning 110 quickly spreads the best agent experiences and/or the best agent policy 46 to entitative service clients. The cross-agent learning 110 thus accelerates reinforcement learning and malware or file-less threat detection across the entity's computer assets. The cross-agent learning 110 supports different learning modes, such as online, off-policy, and offline. The cross-agent learning 110 also supports many algorithms (such as DQN, DDQN, PPO, and multi-agent). The cross-agent learning 110 may implement experience replay sharing, such as copying experience tuples (such as actions 38, states 68, rewards 40) from one, or several, entitative replay buffers 100 to other entitative replay buffers 100. Training, for example, may mix and/or combine tuples and distribute the tuples across entity members. The cross-agent learning 110 may thus implement multi-objective learning where different objectives (such as reward functions) are combined during training. The cross-agent learning 110 may also implement ensemble methods that combine decisions from models with the same goal (i.e., one agent per agentID→ensemble of several in one customerID to yield effectively one ensemble CID agent 20).

The cross-agent learning 110 may also implement policy fusion. The cross-agent learning 110 may combine distributions of different policies 46 after training (for example, taking advantage of one agentID-specific agent 20 having had specialized experience or learning along one path or action sequence resulting in one policy 46 that may be combined with another AID's agent policy 46). Cybersecurity RL agents 20 send their data/action/state 28/30/68 to the cloud computing environment 32. The cloud computing environment 32 facilitates the RL agent learning/training. The cloud computing environment 32, however, may mix/match the data/action/state 28/30/68 from different agents 20 at the training batch creation stage. The cloud computing environment 32 may additionally or alternatively combine the resulting policies 46 via ensemble or fusion techniques.

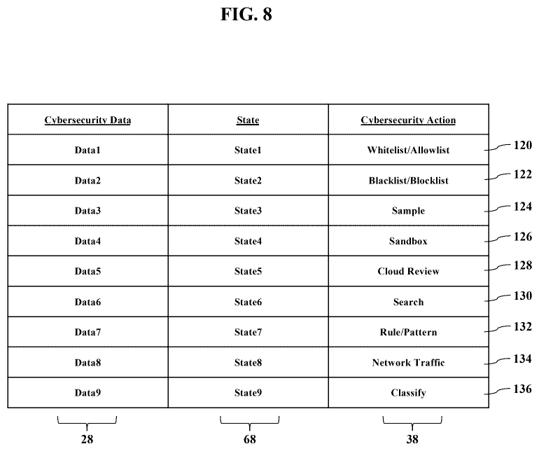

FIG. 8 illustrates examples of agent experiences. As the cybersecurity RL agent 20 operates, the cybersecurity RL agent 20 inspects and analyzes the recent/current cybersecurity data 28 and/or state 68 (as illustrated and explained with reference to FIGS. 1-4). The cybersecurity RL agent 20 determines the responsive cybersecurity action 30 using the reinforcement learning 36 and the reward/penalty 40/42 (as illustrated and explained with reference to FIGS. 1-4). The cybersecurity RL agent 20, in other words, generates a decision (using the reinforcement learning 36), and that decision triggers the corresponding cybersecurity action 30. The cybersecurity RL agent 20 may additionally or alternatively generate an action recommendation that tags/recommends the corresponding cybersecurity action 30.

The cybersecurity RL agent 20 may monitor for predefined or unknown data/states 28/68. As the endpoint host computer system 24 operates, data/states 28/68 evolve and the operating system 52 notifies the cybersecurity RL agent 20 of evolving/changing events (via the event notifications 66, as explained and illustrated with reference to FIG. 2). A new file, for example, may be written to disk, or a new process is started, or a file is modified or accessed. Whatever the events, the events are captured at a very low level on the operating system 52 by the cybersecurity RL agent 20. The sequence or stream of events triggers an evaluation overall of what is the data/states 28/68. The operating system 52, as examples, may notify of how many processes are currently running, what new process is starting, what command line is being executed, and whatever other events are specified. The operating system 52 notifies the cybersecurity RL agent 20 of the events, and the events allow the cybersecurity RL agent 20 with a feature extractor to create a state representation with which to evaluate the policy 46 and to determine the next cybersecurity action 30. The sequence or stream of events contribute to the agent's determination according to its policy 46 of the cybersecurity action 30 to implement (via the operating system 52). The cybersecurity RL agent 20 may thus be constantly evaluating the data/states 28/68 in relation to the policy 46.

FIG. 8, for example, lists some examples of agent experiences that may automatedly/decisionally trigger the responsive cybersecurity action 30. One combination of the cybersecurity data 28 and/or state 68, for example, may trigger the cybersecurity action 30 to add/update the data/state 28/68 to a whitelist/allowlist 120. The data/state 28/68, for example, may describe or reference a filename, processID, driver, IP address, domain, or other identifier that is allowed to load, initialize, execute, or access. Another data/state 28/68, however, may trigger an automated addition/update to a blacklist/blocklist 122. Some data/state 28/68, in other words, may trigger automated blocking to prevent loading, initializing, executing, or accessing. The cybersecurity RL agent 20 may thus implement and update the whitelist/allowlist 120 and the blacklist/blocklist 122 via interfacing with the operating system 52 as the antimalware driver 64 (as illustrated and explained with reference to FIGS. 1-4).

Additional cybersecurity actions 30 may be triggered. The cybersecurity data 28 and/or state 68, for example, may trigger the cybersecurity action 30 to generate/capture and store a sample 124 (perhaps of the data/state 28/68). The cybersecurity RL agent 20, for example, may generate a prompt that is displayed/presented to the user. The prompt may request permission to generate and/or analyze the sample 124 (such as uploading the sample 124 to the cloud computing environment 32). The policy 46, however, may specify that the sample 124 is automatically uploaded to the cloud computing environment 32 for reporting and analysis (such as a company/corporate/entity 102 configuration). The RL-based cybersecurity intrusion detection service 44, for example, may require that the sample 124 be uploaded/shared for experimental use, feature extraction, and other services. The data/state 28/68, as more examples, may trigger automated submission to a protective sandbox 126 or other environment for testing/usage containment. The sandbox 126 may be locally implemented via the operating system 52. The sandbox 126, however, may be remotely implemented in the cloud computing environment 32. The sample 124 may be shared with the cloud computing environment 32 and safely detonated in the sandbox 126. The data/state 28/68, as more examples, may trigger automated submission to a cloud review 128 (such as intel, malware research, and production efforts). The data/state 28/68, in other words, may be uploaded and queued for whatever effort that improves the RL-based cybersecurity intrusion detection service 44.

Some examples further explain sampling. Because the operating system 52 notifies the cybersecurity RL agent 20 of events, the cybersecurity RL agent 20, for example, may collect the events as the sample 124. Suppose, for example, that the endpoint host computer system 24 is exposed to a file-based attack (such as, for example, via insertion of an infected USB drive or via click/select/download of an email attachment). Because the endpoint host computer system 24 (such as a laptop, tablet, or IoT device) may have limited hardware/software resources, local analysis may be insufficient to fully analyze the sample 124. The endpoint host computer system 24, in other words, may lack hardware/software resources to reason in a timely, efficient, and/or confident manner about the character of the sample 124. The cybersecurity RL agent 20, instead, may instruct the operating system 52 to upload the sample 124 to the cloud computing environment 32. The cloud computing environment 32 has greater computational power and additional processes that evaluate the sample 124.

Additional cybersecurity actions 30 may be triggered. The cybersecurity data 28 and/or state 68, for example, may trigger the cybersecurity action 30 to search 130 for similar historical data/state 28/68. The search 130, for example, may be locally conducted of the historical entries logged by the entitative replay buffer 100 (as explained with reference to FIGS. 6-7). The search 130, however, may additionally or alternatively remotely conducted of cloud logs/databases/resources affiliated with the cloud computing environment 32. The search 130 may be of whatever granularity is desired (such as same company/corporate/entity 102, same vertical, same cloud, look-back 12 hours, 7 days, 30 days). The search 130, for example, may look for similar files that had already been uploaded previously. The search 130, as more examples, may look for files, that had been previously/historically analyzed and judged to be a particular malware (such as, for example, a ransomware executable file). The search 130, as more examples, may look for previous/historical events, such as an object or a series of command lines. Suppose, for example, that the endpoint host computer system 24 runs a command line that executes a script. Inside the script, however, may be a called process that loads, for example, a ransomware from a URL, and then the script tries to locally execute that ransomware. These events (i.e., the combination of these steps) may be considered an event. That event in and of itself may be quite unique, because it calls a perhaps even generated domain where this malware sample is downloaded from, and puts it into a randomly generated folder name, locally, and executes it. The cybersecurity RL agent 20 and/or the cloud computing environment 32, however, may search for historical samples 124 representing a similar sequence of steps, a similar sequence of commands and scripts, downloads, and/or other computer actions/behaviors that perhaps exhibit a similar pattern. The randomly generated URL, for example, may have common historical computer actions/behaviors that can be observed (such as the randomly generated local folder). Again, by triggering the search 130 for similar historical data/states 28/68, the cybersecurity RL agent 20 and/or the cloud computing environment 32 may match context with historical records.

Additional cybersecurity actions 30 may be triggered. The cybersecurity data 28 and/or state 68, as more examples, may trigger the cybersecurity action 30 to suggest a new/updated rule/pattern 132 (perhaps based on the data/state 28/68). The cybersecurity RL agent 20, for example, may have learned (such as through repeated rewards 40) that the data/state 28/68 represents the malware 62 (illustrated in FIG. 2). The cybersecurity RL agent 20 may thus generate a rule suggestion as the cybersecurity action 30 to develop a regular expression, logical rule, or other representation that associates the data/state 28/68 as the malware 62. The cybersecurity data 28 and/or state 68, as still more examples, may trigger the cybersecurity action 30 to analyze network traffic 134 (such as logs and/or packet header/payload data). The cybersecurity RL agent 20, for example, may instruct the operating system 52 to notify of inbound/outbound network traffic 134 and await inspection and local/cloud analysis. The cybersecurity RL agent 20 may thus approve or block the inbound/outbound network traffic 134. The cybersecurity RL agent 20 may thus monitor and approve/deny inbound/outbound network traffic 134 conducted by its host router, gateway, or other endpoint computer system 24. The cybersecurity RL agent 20 may further classify 136 the inbound/outbound network traffic (such as normal/suspicious).

Some examples further explain rule suggestions. Suppose, for example, that the cybersecurity RL agent 20 and/or the cloud computing environment 32 determines an event is similar to a known-bad historical event. The cybersecurity RL agent 20 and/or the cloud computing environment 32 may thus mark or create a rule based off of that known cybersecurity historical assessment. The cybersecurity RL agent 20 may then instruct the operating system 52 to skip/fail/block similar event(s). This example may be analogous to a binary being unknown, being then sent through a sandbox, and having an analysis run. Similar matches may thus be marked as known-bad without repeating the assessment. If, however, a known-bad (or known-good) determination cannot be made with high confidence, the cybersecurity RL agent 20 and/or the cloud computing environment 32 may suggest a rule specifying a known-bad (or known-good) determination cannot be made. Indeed, if no historical match or similarity can be determined, the cybersecurity RL agent 20 and/or the cloud computing environment 32 may suggest a rule specifying further analysis is required (such as a human review). Similar matches to known-good events, of course, may also suggest allow rules without repeating assessments. The cybersecurity RL agent 20 and/or the cloud computing environment 32 may also generate a rule template that an analyst may implement with further tweaking.

Still more cybersecurity actions 30 may be triggered. The cybersecurity data 28 and/or state 68, for example, may trigger multiple cybersecurity actions 30. That is, one or more data/states 28/68 may trigger multiple/different cybersecurity actions 30. The multiple/different cybersecurity actions 30 may be nearly simultaneously implemented (such as via interfacing with the operating system 52 as the antimalware driver 64) or serially/sequentially implemented. A subsequent cybersecurity action 30, for example, may be selected and implemented after an initial cybersecurity action 30 is started/requested/finished. Multiple cybersecurity actions 30 may be nested to implement custom trigger configurations.

The cybersecurity RL agent 20 thus provides a nimble and effective endpoint detection and response solution. The cybersecurity RL agent 20 may be components of an endpoint detection and response tool that detects nefarious or suspicious activities associated with the operating system 52 and/or the software applications 60. The cybersecurity RL agent 20, perhaps functioning as the antimalware driver 64, may be downloaded and installed to any server, switch, router, smartphone, or other endpoint host computer system 24. The cybersecurity RL agent 20 may instruct the kernel of the operating system 52 to monitor for data/states 28/68 of interest (as previously explained). The cybersecurity RL agent 20 may thus continuously monitor its endpoint host computer system 24 to detect and to respond to any event, activity, or operation. The cybersecurity RL agent 20, for example, may monitor for, detect, and/or block suspicious operations, even before online communication is established. The cybersecurity RL agent 20 provides cyber security service and detects evidence of misappropriation and exfiltration, even while offline. The cybersecurity RL agent 20 may thus be a local endpoint detection and response (EDR) solution.

The cybersecurity RL agent 20 may also integrate with an XDR solution. Extended detection and response (XDR) collects threat data from siloed security tools across an organization's technology stack. The cybersecurity RL agent 20 may upload the data/states 28/68 from the endpoint host computer system 24 to the cloud-computing environment 32. Uploaded data may then be unified/merged with other data collected from other platforms, perhaps filtered and condensed into a single console.

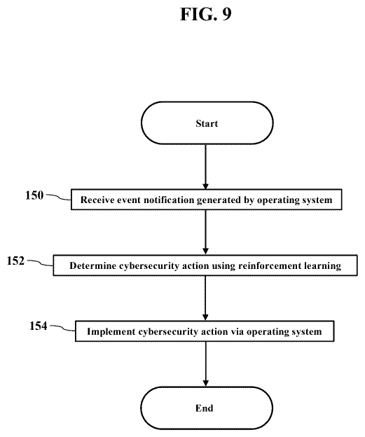

FIG. 9 illustrates examples of a method or operations that implement the cybersecurity action 38 using the reinforcement learning 36. The endpoint cybersecurity RL agent 20, executed by the endpoint host computer system 24, receives the event notification 66 generated by the operating system 52 (Block 150). The endpoint cybersecurity RL agent 20 determines the cybersecurity action 38 using the reinforcement learning 36 in response to the event notification 66 (Block 152). The endpoint cybersecurity RL agent 20 implements the cybersecurity action 38 via the operating system 52 (Block 154).

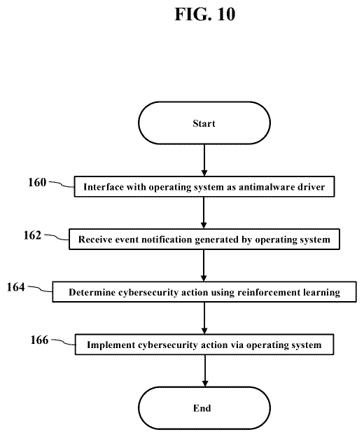

FIG. 10 illustrates examples of another method or operations that implement the cybersecurity action 38 using the reinforcement learning 36. The endpoint cybersecurity RL agent 20 interfaces with the operating system 52 as the antimalware driver 64 (Block 160). The endpoint cybersecurity RL agent 20 receives the event notification 66 generated by the operating system 52 (Block 162). The endpoint cybersecurity RL agent 20 determines the cybersecurity action 38 using the reinforcement learning 36 in response to the event notification 66 (Block 164). The endpoint cybersecurity RL agent 20 implements the cybersecurity action 38 using the operating system 52 (Block 166).

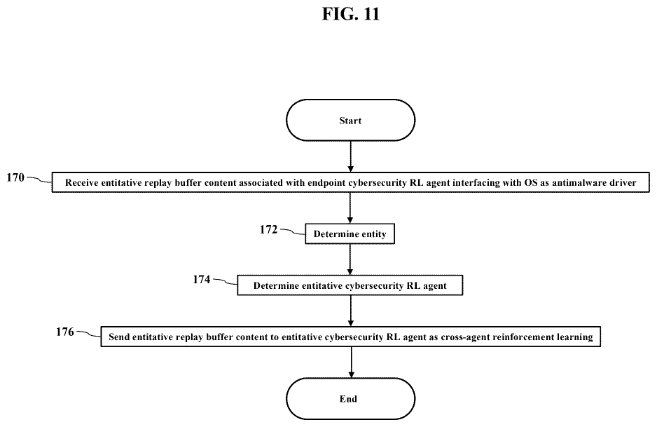

FIG. 11 illustrates examples of still more methods or operations that implement the cybersecurity action 38 using the reinforcement learning 36. The cloud computing environment 32 (such as the cloud server 80 illustrated in FIG. 5) receives the content representing at least some portion of the entitative replay buffer 100 associated with the endpoint cybersecurity RL agent 20 interfacing with the host's operating system 52 as the antimalware driver 64 (Block 170). The cloud computing environment 32 determines the entity 102 (Block 172) and another endpoint cybersecurity reinforcement learning agent 20 associated with the entity 102 (Block 174). The cloud computing environment 32 sends the entitative replay buffer content to the other endpoint cybersecurity reinforcement learning agent 20 as the cross-agent reinforcement learning 110 (Block 176).

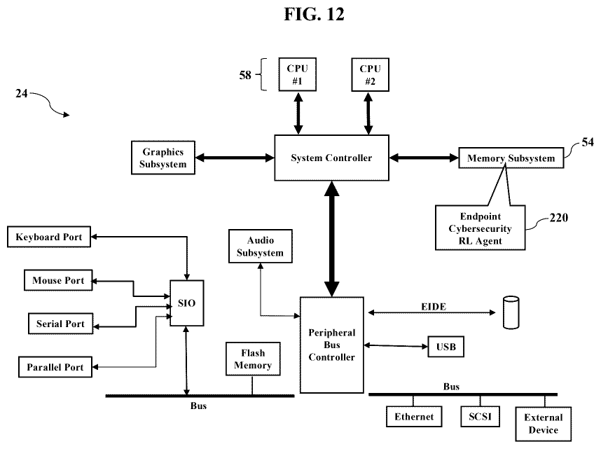

FIG. 12 illustrates more detailed examples of the operating environment. FIG. 12 is a more detailed block diagram illustrating the endpoint host computer system 24. The endpoint cybersecurity RL agent 20 is stored in the memory subsystem or device 54. One or more of the hardware processors 56 communicate with the memory subsystem or device 54 and execute the endpoint cybersecurity RL agent 20. Examples of the memory subsystem or device 56 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and other read/write memory technology.

The computer system 24 may have other embodiments. This disclosure mostly discusses the computer system 24 as the rack server 50. The RL-based intrusion detection service 44, however, may be easily adapted to other stationary or mobile computing examples, such as a desktop computer, a tablet computer, a smartwatch, and a network switch/router. The RL-based intrusion detection service 44 may also be easily adapted to other embodiments of smart devices, such as a television, an audio device, a remote control, and a recorder. The RL-based intrusion detection service 44 may also be easily adapted to still more smart appliances, such as washers, dryers, and refrigerators. Indeed, as cars, trucks, and other vehicles grow in electronic usage and in processing power, the RL-based intrusion detection service 44 may be easily incorporated into a vehicular controller.

The above examples of the RL-based intrusion detection service 44 may be applied regardless of the networking environment. The RL-based intrusion detection service 44 may be easily adapted to stationary or mobile devices having wide-area networking (e.g., 4G/LTE/5G/6G/7G cellular), wireless local area networking (WI-FI®), near field, and/or BLUETOOTH® capability. The RL-based intrusion detection service 44 may be applied to stationary or mobile devices utilizing any portion of the electromagnetic spectrum and a signaling standard (such as the IEEE 802 family of standards, GSM/CDMA/TDMA or other cellular standard, and/or the ISM band). The RL-based intrusion detection service 44, however, may be applied to a processor-controlled device operating in the radio-frequency domain and/or the Internet Protocol (IP) domain. The RL-based intrusion detection service 44 may be applied to a processor-controlled device utilizing a distributed computing network, such as the Internet (sometimes alternatively known as the “World Wide Web”), an intranet, a local-area network (LAN), and/or a wide-area network (WAN). The RL-based intrusion detection service 44 may be applied to a processor-controlled device utilizing power line technologies, in which signals are communicated via electrical wiring. Indeed, the many examples may be applied regardless of physical componentry, physical configuration, or communications standard(s).

The RL-based intrusion detection service 44 may utilize a processing component, configuration, or system. For example, the RL-based intrusion detection service 44 may be easily adapted to a desktop, mobile, or server central processing unit or chipset offered by INTEL®, ADVANCED MICRO DEVICES®, ARM®, APPLE®, TAIWAN SEMICONDUCTOR MANUFACTURING®, QUALCOMM®, or other manufacturer. The RL-based intrusion detection service 44 may even use multiple central processing units or chipsets, which could include distributed processors or parallel processors in a single machine or multiple machines. The central processing unit or chipset can be used in supporting a virtual processing environment. The central processing unit or chipset could include a state machine or logic controller. When any of the central processing units or chipsets execute instructions to perform “operations,” this could include the central processing unit or chipset performing the operations directly and/or facilitating, directing, or cooperating with another device or component to perform the operations.

The RL-based intrusion detection service 44 may be applied regardless of the operating system. The RL-based intrusion detection service 44 may be applied or adapted to processor-controlled devices executing the MICROSOFT® operating system (such as a version of the WINDOWS® and WINDOWS SERVER® operating systems). The RL-based intrusion detection service 44 may be applied or adapted to processor-controlled devices executing the APPLE® operating systems (such as a version of the MACOS®, IOS®, and OS® operating systems). The RL-based intrusion detection service 44 may be applied or adapted to processor-controlled devices executing a version of the LINUX®, ANDROID®, CHROMEOS®, UNIX®, and other operating systems.

The RL-based intrusion detection service 44 may use packetized communications. When the computer system 24 communicates via communications networks, information may be collected, sent, and retrieved. The information may be formatted or generated as packets of data according to a packet protocol (such as the Internet Protocol). The packets of data contain bits or bytes of data describing the contents, or payload, of a message. A header of each packet of data may be read or inspected and contain routing information identifying an origination address and/or a destination address.

The RL-based intrusion detection service 44 may utilize a signaling standard. The computer system 24 and/or the cloud computing environment 32 may mostly use wired networks to interconnect network members. However, the computer system 24 and/or the cloud computing environment 32 may utilize other communications devices using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or a variant of the GSM/CDMA/TDMA signaling standard. The RL-based intrusion detection service 44 may also utilize other standards, such as the I.E.E.E. 802 family of standards, the Industrial, Scientific, and Medical band of the electromagnetic spectrum, BLUETOOTH®, low-power or near-field, and other standard or value.

The RL-based intrusion detection service 44 may be physically embodied on or in a computer-readable storage medium. This computer-readable medium, for example, may include CD-ROM, DVD, tape, cassette, floppy disk, optical disk, USB flash memory drive, memory card, memory drive, and large-capacity disks. This computer-readable medium, or media, could be distributed to end-subscribers, licensees, and assignees. A computer program product comprises processor-executable instructions for implementing the cybersecurity action 30 using the reinforcement learning 36, as the above paragraphs explain.

The diagrams, schematics, illustrations, and the like represent conceptual views or processes illustrating examples of the cybersecurity RL agent 20. The functions of the various elements shown in the figures may be provided through the use of dedicated hardware as well as hardware capable of executing instructions. The hardware, processes, methods, and/or operating systems described herein are for illustrative purposes and, thus, are not intended to be limited to a particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method executed by a computer system that implements a cybersecurity action using a reinforcement learning, comprising:
receiving, by an endpoint cybersecurity reinforcement learning agent executed by the computer system, an event notification generated by an operating system;
determining, by the endpoint cybersecurity reinforcement learning agent using the reinforcement learning, a cybersecurity action in response to the event notification; and
implementing, by the endpoint cybersecurity reinforcement learning agent executed by the computer system, the cybersecurity action via the operating system.

2. The method of claim 1, further comprising updating an allowlist as the cybersecurity action implemented via the operating system.

3. The method of claim 1, further comprising updating a blocklist as the cybersecurity action implemented via the operating system.

4. The method of claim 1, further comprising generating a sample as the cybersecurity action implemented via the operating system.

5. The method of claim 1, further comprising sandboxing a sample as the cybersecurity action implemented via the operating system.

6. The method of claim 1, further comprising requesting a review of a sample as the cybersecurity action implemented via the operating system.

7. The method of claim 1, further comprising conducting a search as the cybersecurity action implemented via the operating system.

8. The method of claim 1, further comprising generating a rule suggestion as the cybersecurity action implemented via the operating system.

9. The method of claim 1, further comprising classifying network traffic as the cybersecurity action implemented via the operating system.

10. The method of claim 1, wherein in response to the determining of the cybersecurity action, further comprising triggering a subsequent action by the cybersecurity reinforcement learning agent.

11. A computer system that implements a cybersecurity action using a reinforcement learning, comprising:
at least one central processing unit executing an operating system; and
at least one memory device storing instructions that, when executed by the at least one central processing unit, perform operations, the operations comprising:
interfacing, by an endpoint cybersecurity reinforcement learning agent, as an antimalware driver with the operating system;
receiving, by the endpoint cybersecurity reinforcement learning agent, an event notification generated by the operating system;
determining, by the endpoint cybersecurity reinforcement learning agent using the reinforcement learning, a cybersecurity action in response to the event notification; and
implementing, by the endpoint cybersecurity reinforcement learning agent, the cybersecurity action using the operating system.

12. The computer system of claim 11, wherein the operations further comprise requesting a sample as the cybersecurity action implemented using the operating system.

13. The computer system of claim 11, wherein the operations further comprise sandboxing a sample as the cybersecurity action implemented using the operating system.

14. The computer system of claim 11, wherein the operations further comprise requesting a review of a sample as the cybersecurity action implemented using the operating system.

15. The computer system of claim 11, wherein the operations further comprise conducting an event search as the cybersecurity action implemented using the operating system.

16. The computer system of claim 11, wherein the operations further comprise suggesting a cybersecurity rule as the cybersecurity action implemented using the operating system.

17. The computer system of claim 11, wherein the operations further comprise classifying packet traffic as the cybersecurity action implemented using the operating system.

18. The computer system of claim 11, wherein the operations further comprise triggering a subsequent action by the cybersecurity reinforcement learning agent.

19. A memory device storing instructions that, when executed by a central processing unit, perform operations, comprising:
receiving an entitative replay buffer content associated with an endpoint cybersecurity reinforcement learning agent interfacing with an operating system as an antimalware driver;
determining an entity associated with the entitative replay buffer content and the endpoint cybersecurity reinforcement learning agent;
determining another endpoint cybersecurity reinforcement learning agent associated with the entity; and
sending the entitative replay buffer content to the another endpoint cybersecurity reinforcement learning agent as cross-agent reinforcement learning.

20. The memory device of claim 19, wherein the operations further comprise:
generating a policy based on the entitative replay buffer content; and
sending the policy to the another endpoint cybersecurity reinforcement learning agent.
